(19) United States
(12) Patent Application Publication
(10) Pub. No.: US 2014/0201183 A1
(43) Pub. Date: Jul. 17, 2014

(54) Personalized Content Delivery System and Method

(71) Applicants: Qian Lin, Santa Clara, CA (US); Jerry Liu, Sunnyvale, CA (US); Eamonn O'brien-Strain, Palo Alto, CA (US)

(72) Inventors: Qian Lin, Santa Clara, CA (US); Jerry Liu, Sunnyvale, CA (US); Eamonn O'brien-Strain, Palo Alto, CA (US)

(21) Appl. No.: 14/238,206

(22) PCT Filed: Sep. 30, 2011
(86) PCT No.: PCT/US11/54150

§ 371 Date: Feb. 11, 2014

(51) Int. Cl. G06F 17/30

(52) U.S. Cl. CPC G06F 17/30867
USPC 707/706

(57) ABSTRACT

A system and method are provided to deliver personalized content to a user. The system includes a memory for storing computer executable instructions and a processing unit for accessing the memory and executing the computer executable instructions. The computer executable instructions include an engine to apply content extraction rules based on at least one pre-determined delivery schedule to extract content of interest pointed to by links in user-selected sections of at least one content portal of at least one web page regardless of changes in the links in the at least one content portal. The computer executable instructions also include a module to compose the extracted content in a layout format to provide personalized content. The system includes computer executable instructions to deliver the personalized content to at least one pre-determined destination according to the at least one pre-determined delivery schedule.

### BACKGROUND

Content such as newspapers and magazines are increasingly accessible from web portals. A user can visit a web site and select individual links to articles. Currently, some services use RSS feed mechanisms to provide web content to users directly, such as blog entries, news headlines, audio, and video, in a standardized format. However, these RSS feeds depend on the web content owner for deployment. In addition, these RSS feeds are available for only a small part of web content available on the internet.

### DESCRIPTION OF DRAWINGS

FIG. 1 is a block diagram of an example of a content delivery system.

FIG. 2A is a block diagram of an illustrative functionality for use in configuring content delivery, implemented by an example computerized content delivery system.

FIG. 2B is a block diagram of an illustrative functionality for use in generating content extraction rules, implemented by an example computerized content delivery system.

FIG. 2C is a block diagram of an illustrative functionality for use in extracting content using content extraction rules, implemented by an example computerized content delivery system.

FIG. 3 illustrates an example of a user interface for indicating user-selection sections on a web page.

FIG. 4 illustrates an example of a user interface for organizing delivery.

FIG. 5 illustrates an example of extracted content converted into RSS feed.

FIGS. 6A and 6B illustrate examples of content extraction using content extraction rules.

FIG. 7 illustrates an example of composed extracted content.

FIG. 8 is a flow diagram of an example of a method for configuring content delivery.

FIG. 9 is a flow diagram of an example of a method for generating content extraction rules.

FIG. 10 is a flow diagram of an example of a method for extracting content using content extraction rules.

FIG. 11 is a block diagram of an example of a computer that incorporates an example of a content delivery system.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

A “computer” is any machine, device, or apparatus that processes data according to computer-executable instructions, including machine readable instructions, that are stored on a computer-readable medium either temporarily or permanently. A “software application” (also referred to as software, an application, computer software, a computer application, a program, and a computer program) is a set of machine readable instructions that an apparatus, e.g., a computer, can interpret and execute to perform one or more specific tasks. A “data file” is a block of information that durably stores data for use by a software application.

The term “computer-readable medium” refers to any medium capable storing information that is readable by a machine (e.g., a computer). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

The term “web page” refers to a document that can be retrieved from a server over a network connection (including a wireless network) and viewed in an application, including a web browser application.

As used herein, the term “includes” means includes but not limited to, the term “including” means including but not limited to. The term “based on” means based at least in part on.

Content such as newspapers and magazines are increasingly accessible from web portals. A use can visit a web site and select individual pages with articles to read. The user experience may not be satisfactory since the web pages often include a large amount of auxiliary content, including advertisement. Often, the article of interest may be distributed across multiple web pages and have more advertisement display. Also, it can be tedious for a user to click on and follow a large number of links to read through various articles, as it may require traversing multiple web pages to view all the user-desired content.

To facilitate a user's access to web content, a system and method is describes that allows a user to annotate topics of interest directly from web portals. A system and method herein enables automatic extraction of content that is of interest to a user, and delivery of that content of interest to the user's devices.

The extracted content can be delivered in various formats, for example according to a user preference. The extracted content may be delivered as a Portable Document Format (PDF) document, as a web page (for example, based on a markup language file), or in an electronic book format (including an ebook or other electronic book accessible by an electronic reader). Non-limiting examples of applicable markup language files include a HTML file based on a variation of the markup language, including XHTML and HTML5, and a markup language embedded in or called from HTML including Cascade Style Sheet (CSS) and JavaScript. In an example, the extracted content is delivered in an electronic book format, including as an EPUB® file (a *.epub file). In an example, the extracted content may be delivered as a link in an electronic transmission (such as email), and the user gains access to the body of the extracted content by following the link.

In a non-limiting example implementation, the extracted content is delivered to a portable device, including a smartphone, a tablet, a slate, or other touch-based device or other hand-held device, a laptop, a notebook, or other portable computer-based device. In a non-limiting example implementation, the extracted content is delivered to a computer-based viewing device that may be part of a booth, a kiosk, a pedestal or other type of physical support.

In an example, the extracted content is considered delivered to a designated destination if a user utilizes a device (including a portable device and a computer-based viewing device) to access and/or view the extracted content, including by following a link.

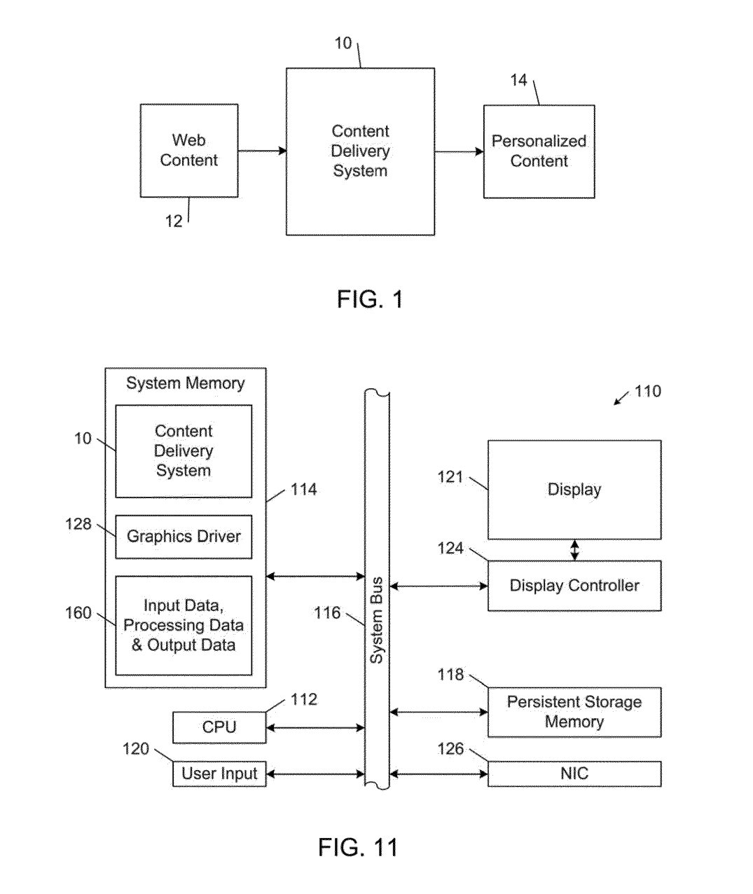

FIG. 1 shows an example of a content delivery system 10 that performs document transformation on web content 12 and outputs personalized content 14. Content delivery system 10 can provide a fully automated process for web content extraction and delivery.

In some examples, the content delivery system 10 outputs the results from operation of content delivery system 10 by storing them in a data storage device (including, in a database) or rendering them on a display (including, in a user interface generated by a software application). Example displays include the display screen of a portable device, including a smartphone, a tablet, a slate, or other touch-based device or other hand-held device, a laptop, a notebook, or other portable computer-based device. Other example displays include the display screen of a computer-based viewing device that may be part of a booth, a kiosk, a pedestal or other type of physical support.

In an example, a system and method described herein is configured to allow a user to access personalized content that is aggregated from multiple we sources and delivered to the user at the user's destination of choice. The system can include a client-based component for setting up the web content selections. The system can include a server-based component for analyzing the selections. The server-based component can be used to fetch the web content selections and to deliver the web content selections to the designated destination.

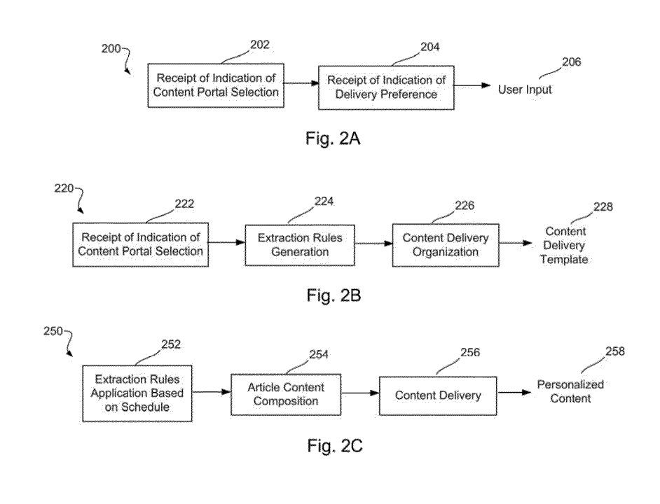

Referring now to FIGS. 2A, 2B and 2C, block diagrams are shown of illustrative functionalities 200, 220 and 250 implemented by different components of content delivery system 10 for content extraction and delivery consistent with the principles described herein. Each module in the diagrams represents one or more elements of functionality performed by a processing unit. The operations of each module depicted in FIGS. 2A, 2B and 2C can be performed by more than one module. Arrows between the modules represent the communication and interoperability among the modules.

The block diagram of FIG. 2A depicts functionality 200 of an example implementation of a system and method described herein for receiving user input for use in configuring content delivery to the user. In block 202, user input is received which indicates the selection of the sections of links in at least one content portal of a web page that point to the articles of interest. In block 204, user input is received which indicates the user-specified content delivery schedule, delivery destinations, and the format in which the extracted content is to be delivered. The output is information indicative of user input 206.

In block 202, at least one module performs the operations to receive input indicative of the user's selection from a content portal. The functionality can be performed by a client-based component. An implementation provides a user with access to a content portal and facilitates use of an interface of the client-based component so that the user can indicate the selections of interest from the content. For example, the selections of interest can be a section of the web page that includes links to the articles of interest. The client-based component provides a user with a tool for use in indicating the selections of interest of the web content.

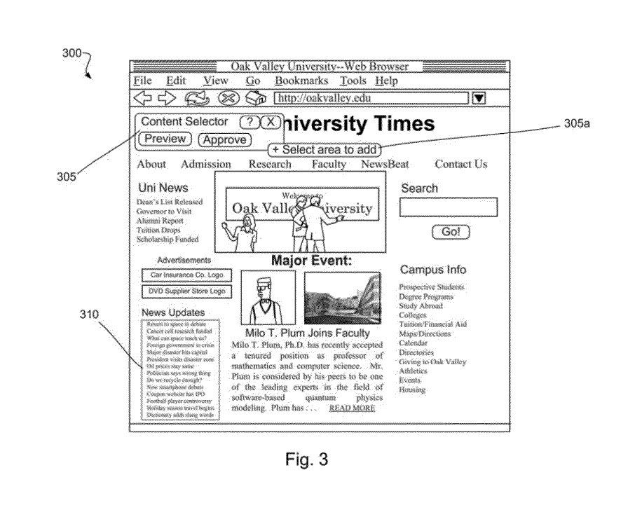

In an example, the client-based component presents a tool 305 that a user can use to select a section of a web page 300, served from a content portal, which includes links to the articles of interest. In the illustration of FIG. 3, the tool 305 is depicted as a Content Selector that includes a prompt 305a to the user to select a region of interest on the web page. The user may indicate the region of interest by drawing a box 310 around it, for example, using a cursor provided by tool 306. Any manner of indicating the section of interest is applicable. For example, the user may drag different shaped indicators around the section of interest. In the example of FIG. 3, the user uses tool 305 to draw box 310 which surrounds the area of interest on web page 300. The links selected in box 310 are served from a content portal which sources links to articles that are of interest to the user.

In an example, for selecting the section(s) of interest on a web page, the client-based component can present a content selector tool that allows a user to highlight, drag-and-drop, or draw a rectangle or other shape around, clip, or in some other manner indicate the section(s). In another example, the selection can be performed, for example, using a client browser plug-in.

The client-based component returns the user-specified information to another component of content delivery system 10 for storage and processing to facilitate content delivery. Non-limiting examples of information returned to the other component of content delivery system 10 include the uniform resource locator (URL) of the content portal and information that describes the user-selected region of the web page. Non-limiting examples of information that describes the user-selected region of the web page include a document object model (DOM) tree annotated with selected nodes or an XPath description (where XPath, XML Path Language, is a query language that is used for selecting nodes from an XML document).

In an example, the operations described in connection with block 202 can be performed on more than one web page. In this example, user input is received which indicates the selection of the sections of links in at least one content portal that point to the articles of interest for each of the web pages.

In block 204, an interface of the client-based component presents a field that requests the user specify a destination for delivery of the extracted content. The extracted content can be delivered to the specified destination through a number of different mechanisms. Non-limiting examples of destinations that the extracted content can be delivered to include a repository that the user creates on a server, an application (including a mobile application) distributed to and installed on the user's portable device, a printer connected to the internet that the user has access to, a retail print fulfillment center that the user specifies, and an email account, in a non-limiting example implementation of block 204, an application can be created and sent to an account that the user has with an electronic print center, which can then be downloaded to the user's printer to facilitate delivery of the extracted content of the user's printer.

The interface of the client-based component can also present a field that requests the user specify a content delivery schedule, including delivery dates and delivery times.

The interface of the client-based component can also present a field that requests the user specify the format in which the extracted content is delivered. The user may specify that the extracted content is delivered as a portable document format (PDF) document, as a web page (for example, based on a markup language file), or in an electronic book format (including an ebook or other electronic book accessible by an electronic reader). Non-limiting examples of applicable markup language files include a HTML file based on a variation of the markup language, including XHTML and HTML5, and a markup language embedded in or called from HTML including Cascade Style Sheet (CSS) and JavaScript. In an example, the extracted content is delivered in an electronic book format, including as an EPUB® file (a *.epub file). In another example, the user may specify that the extracted content is delivered as a link in an electronic transmission (such as email) or a web page and the user gains access to the body of the extracted content by following the link.

In an example where the operations of block 202 are performed on more than one web page, user input is received in block 204 which indicates the user-specified content delivery schedule, delivery destinations, and the format in which the extracted content is to be delivered for each web page. The delivery schedules, delivery destinations and formats for delivery of the extracted content can be specified as the same for content extracted from all web pages, different for content extracted from each different web page, or the same for content extracted from some web pages and not others.

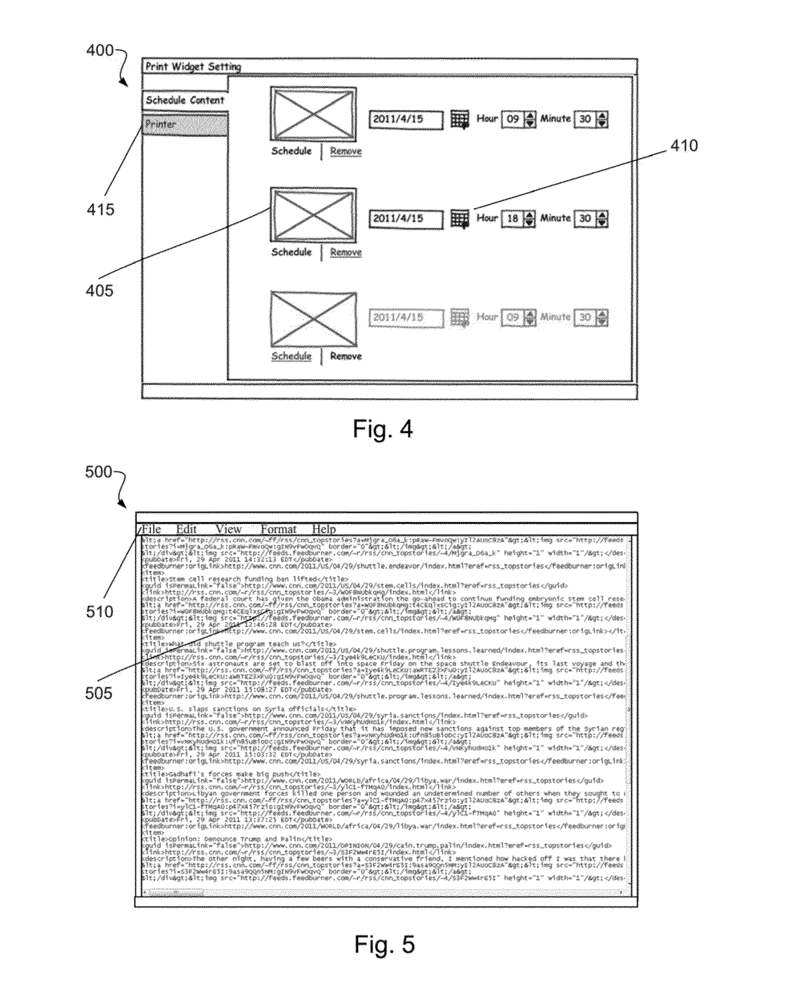

FIG. 4 shows a non-limiting example of an interface 400 that the e client-based component can display to a user to receive the information for setting the content delivery schedule, destinations, and delivery format. Interface 400 could be used to manage content deliveries from multiple different content portals for a user. In FIG. 4, an indication of the region of interest 405 selected on a web page is displayed to a user and a field 410 is provided that allows the user to input information to set the schedule for content delivery. Region 405 in the document includes a collection of links to the articles of interest. Interface 400 also shows a window 415 that can be accessed for setting the delivery destination. In the example of FIG. 4, the window 415 indicates a printer as the destination. However, the interface 400 can be configured to present other options of content delivery destination to the user.

In an example where the operations of blocks 202 and 204 are performed on more than one web page, interface 400 allows a user to complete fields 405, 410 and 415 for each of the web pages. As illustrated in FIG. 4, more than one set of fields 405 and 410 can be displayed to the user on interface 400. Window 415 can present more than one field for receiving information indicative of the user-specified destination, which can be used to specify more than one destination for the extracted content from the web pages.

In an example, the client-based component can be a browser plug-in, or an extension to a computer application. In another example, the client-based component can be stand-alone program.

In an example, a user gains benefit of use of a system implementing functionality 200 by installing the client-based component on a user's client device, including a portable device or a computer-based viewing device.

The block diagram of FIG. 2B depicts functionality 220 of an example implementation of a system and method described herein for setting up a content delivery template. In a non-limiting example, the operations of functionality 220 are performed by a component of content delivery system 10 that is server-based. In block 222, information indicative of user input is received. The user input indicates the selection of the sections of links in a content portal of a web page that point to the articles of interest. In block 224, content extraction rules are generated. The document structure of the web page that includes links pointing to the articles of interest is analyzed. Content extraction rules are derived based on the results of the analysis. In a non-limiting example, the document structure of a web page is analyzed to locate positions of links in the DOM tree of the web page. In block 226, content delivery is organized. In a non-limiting example, organization of the content delivery includes setting the delivery schedule and the delivery destinations based on the user's specifications. The format in which the extracted content is delivered is also specified. A content delivery template 228 is developed that includes the content extraction rules generated in block 224. The content delivery organization information from block 226 is used to configure the content delivery template 228 so that, when implemented, the extracted content is delivered in the specified format to the specified destinations according to the specified schedule. The content delivery template 228 also includes information indicative of the delivery schedule, the delivery destinations, and the format in which the extracted content is to be delivered.

In an example, the operations described hereinbelow in connection with blocks 222, 224 and 226 can be performed on more than one web page. In this example, information indicative of user input is received in block 222 for each of the web pages. In block 224, content extraction rules are generated based on the analysis of the document structure of each of the web pages that includes the links pointing to the articles of interest. In block 226, content delivery is organized for delivery of the extracted content from each of the web pages. One or more content delivery templates 228 can be developed that includes the content extraction rules generated in block 224. For example, a single content delivery template can be generated for extracting content from all of the web pages, or different content delivery templates can be generated for extracting content from the web pages, in some combination. The content delivery organization information from block 226 is used to configure the content delivery template 228 so that, when implemented, the extracted content from the web pages is delivered in the specified format to the specified destinations according to the specified schedule.

In block 224, a component of content delivery system 10 processes the user input from block 222. Using the region selection information received in block 222, the structure of the web page is analyzed and content extraction rules are generated. Non-limiting example of systems and methods to implement algorithms that can be used for generating the extraction rules in block 224 are described in international application no. PCT/CN2009/075545 (publication no. WO2011/072434). In brief, the generated content extraction rules facilitate extracting web content in a webpage is extracted by identifying paragraphs in the Web content based on line-break node determination. A range of text-body associated with the identified paragraphs is identified using a maximum scoring subsequence. The identified text-body is refined using a heuristic rule of substantially horizontal alignment. The generated content extraction rules facilitate extracting one or more titles and one or more images associated with the web content. Other non-limiting example systems and methods to implement algorithms that can be used for generating the extraction rules in block 224 are described in international application no. PCT/CN2009/075117 (publication no. WO2011/063561). In brief, the example systems and methods extract content from a target web page (where the links of interest point to) by selecting data of interest in a source web page (the web page including the links of interest) and trying to locate corresponding data in a target web page by determining similarities in the DOM tree representations of the source and target web pages. The content extracting rules can be generated by defining a set of DOM trees that include the DOM tree of the source web page and a truncated DOM tree of the target web page, the truncated tree including all matched paths and all unmatched branches comprising a data node for which an alignment cost does not exceed a predefined threshold. Using the extraction rules includes, for data residing in a node of a path of a subsequent target web page DOM tree matching the node in the matched path of the source web page DOM tree or the truncated target web page DOM tree, extracting the data. The extraction rules can be stored, e.g., on a sever. In an example, extraction rules can be associated with an account created by the user.

In a non-limiting example implementation of block 224, the web page document structure of a web page is analyzed to locate the positions of links in the DOM tree. Content extraction rules are derived to extract the regions containing these links. These content extraction rules can be stored on the server and associated with the user's account.

In an example implementation of content delivery system 10 to deliver content, the content extraction rules generated in block 224 are used to analyze the web page and to analyze the links in the content portal of the regions indicated by the user.

The block diagram of FIG. 2C depicts functionality 250 of an example implementation of a system and method described herein for extracting content according to the extraction rules and delivering the extracted content according to specification. In block 252, extraction rules are applied to extract the content of interest according to the pre-set schedule. An engine analyzes the selection of the sections of links in a content portal of the web page that point to the articles of interest, and extracts the content according to the extraction rules. In block 254, the extracted content is composed according to the format that the user specified. In block 256, the composed content is delivered to the specified delivery destinations to provide the user with the personalized content 258 at the scheduled content delivery time(s). The operations of blocks 252, 254 and 256 can be performed using a server.

In an example, the operations described hereinbelow in connection with blocks 252, 254 and 256 can be performed on more than one web page. In this example, in block 252, extraction rules are applied to extract the content of interest according to the pre-set schedule for each of the web pages. In block 254, the extracted content from each of the web pages is composed according to the format that the user specified. The content extracted from the web pages can be composed into a single final document, or multiple documents, as specified by the user. In block 256, the composed content is delivered to the specified delivery destinations in the specified format(s) to provide the user with the personalized content 258 at the scheduled content delivery time(s).

In an example implementation, the functionality of blocks 252, 254 and 256 are used for run-time execution of content delivery to provide the personalized content 258. The content extraction rules are applied to web pages (consistent with block 252). Web content is fetched and the extracted web content is delivered to designated destinations according to set schedules (consistent with block 256). The schedules can be set and the destinations can be designated a user. Article extraction technology can be applied to extract content from web pages. Non-limiting examples of article extraction technology is described in U.S. patent application Ser. No. 13/052,622, which describes systems and methods that can be used for determining the uniform resource locator associated with a printer friendly version of a webpage and retrieving the content. The extracted content can be composed to a layout structure (consistent with block 254). In an example, the extracted content can be composed to a layout structure specified by a user. In another example, the extracted content can be composed to an automated layout structure generated by a layout system. The composed content is delivered to designated destinations according to set schedules.

In an example, a component of content delivery system 10 applies the content extraction rules to the web page and converts information indicative of the extracted content into an RSS feed. FIG. 5 shows an example window 500 containing RSS feed 505 generated by a component of content delivery system 10. Window 500 provides the user with a menu of tools 510 for managing the RSS feed 505, including options to “Edit” the RSS feed.

In example implementations of functionality 250, content extraction rules are applied to fetch the content of interest from the user-selected content portal. The content portal includes links to the articles of interest. The articles that the links point to may change at on a daily basis, or even at regular intervals throughout the day. As a result, the articles that are linked in the user-selected content portal also may change at on a daily basis, or even at regular intervals throughout the day. Thus, the content of interest fetched when the system retrieves content from the content portal at a first time point may differ from the content fetched when the system retrieves content at a second time point, since the links in the user-selected content portal may change. The content extraction rules generated in block 224 are configured to fetch content at the user-indicated frequency based on the links in the user-selected content portal. In an example implementation of blocks 252, 254 and 256, the web page document structure for a new web page is analyzed at the scheduled time point, and the update links for the articles of interest are collected from the user-selected content portal. Technology is applied to extract article content from the articles accessed by the links, the extracted content is composed according to a layout and the composed content is delivered to the user-specified destinations.

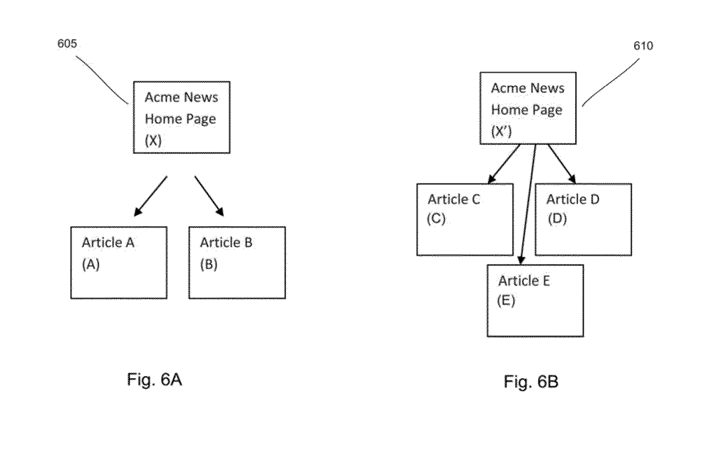

An example implementation of the functionality of 252, 254 and 256 of FIG. 2C is described in connection with the illustrations of FIGS. 6A and 6B. At a scheduled time period, the user-selected content portal of a web page (e.g., Acme News Home Page 605 in FIG. 6A) is analyzed. The user-selected content portal is a section (X) of Acme News Home Page that encompasses links to the articles of interest to the user. The links in the user-selected section (X), including links (A) and (B), are traversed. The articles of interest pointed to by links (A) and (B) are extracted to provide Article A and Article B. Article A and Article B are delivered to the user-specified delivery destinations according to the user-specified delivery schedule. The articles (Article A and Article B) can be composed into a formatted document(s) and delivered to the specified destinations. For example, extracted Article A and Article B can be composed into a single document, such as but not limited to a PDF, a markup language file, an electronic book format, or any other page format, and delivered to the specified destinations. At a subsequent scheduled time period, the user-selected content portal of Acme News Home Page 810 is analyzed (see FIG. 6B). The section of Acme News Home Page 810 that includes the links of interest is depicted as a section (X′) in FIG. 6B. The location of section (X′) on the web page is inferred from the content extraction rules generated based on user-selected section (X), and does not need to be re-indicated by a user at the subsequent time. Some or all of the links in this section (X′) may be different from those in section (X) at the subsequent scheduled time. In the illustration of FIG. 6B, section (X′) includes links (C), (D), and (E) which are different from links (A) and (B). At the subsequent scheduled time period, the links in the user-selected section (X′), including links (C), (D), and (E), are traversed. The articles of interest pointed to by the links in the user-selected section (X′) are extracted. For example, Article C, Article D and Article E are extracted from articles pointed to by links (C), (D), and (E). Article C, Article D and Article E are delivered to the user-specified delivery destinations according to the user-specified delivery schedule. These articles (Article C, Article D and Article E) also can be composed into a formatted document(s) and delivered to the specified destinations. For example, the extracted articles can be composed into a single document, such as but not limited to a PDF, a markup language file, an electronic book format, or any other page format, and delivered to the specified destinations.

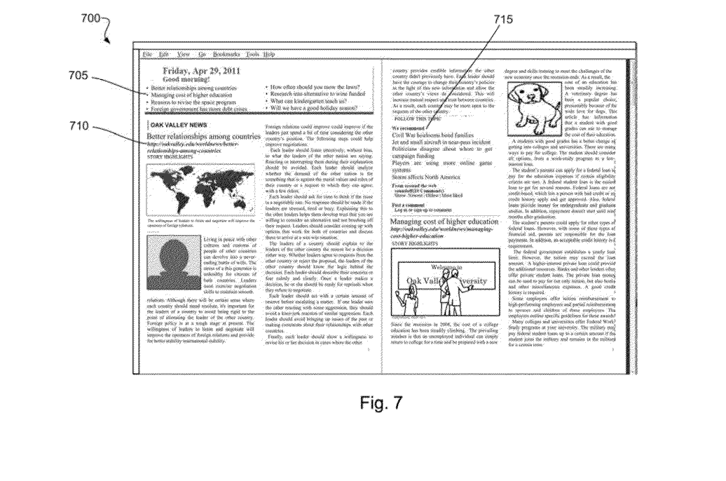

FIG. 7 illustrates an example document 700 that is generated in an example implementation of content delivery system 10. Content delivery system 10 extracts the content of articles of interest from each link in the user-selected section of the web page, and aggregates the content to provide document 700. Document 700 is composed from the content extracted from the articles pointed to by the links. Document 700 provides a listing of the titles 705 of the articles extracted. Example document 700 also provides, for each article extracted, the uniform resource locator (URL) 710 of the link pointing to the article at its source. The content can be formatted to provide document 700 using any document content composition tool in the art. As illustrated in example document 700, the content delivery system may also provide a section 715 that includes links to additional articles that might be of interest to the user based on analysis of the user-selected section of the web page.

As illustrated in the example implementation of FIGS. 6A, 6B and 7, a system and method provided herein facilitates aggregating web articles that do not exist at the time that a user selects the content portal on the web page that includes links to the articles of interest. For example, where the web page is a news outlet, the content extraction rules are generated to facilitate extracting, e.g., future financial news stories. A system and method according to the principles herein allow a user to clip from a region of a web page where future content of interest, i.e., articles that do not yet exist, will appear in the future. A system and method according to the principles herein is not dependent on the existence of RSS links at the time the content portal of the web page is selected to aggregate news stories for delivery to the user. In a non-limiting example, an RSS document includes full or summarized text, plus metadata such as publishing dates and authorship.

A system and method according to a principle described herein can provide a superior reading experience to a user by collecting content in one place without requiring the user to click through multiple links manually. A system and method herein can be applied to much of the content of a web page. The content selection can be more direct from the perspective of the user, since the mark-up to indicate the section including the articles of interest on the we page is done directly from the content portal.

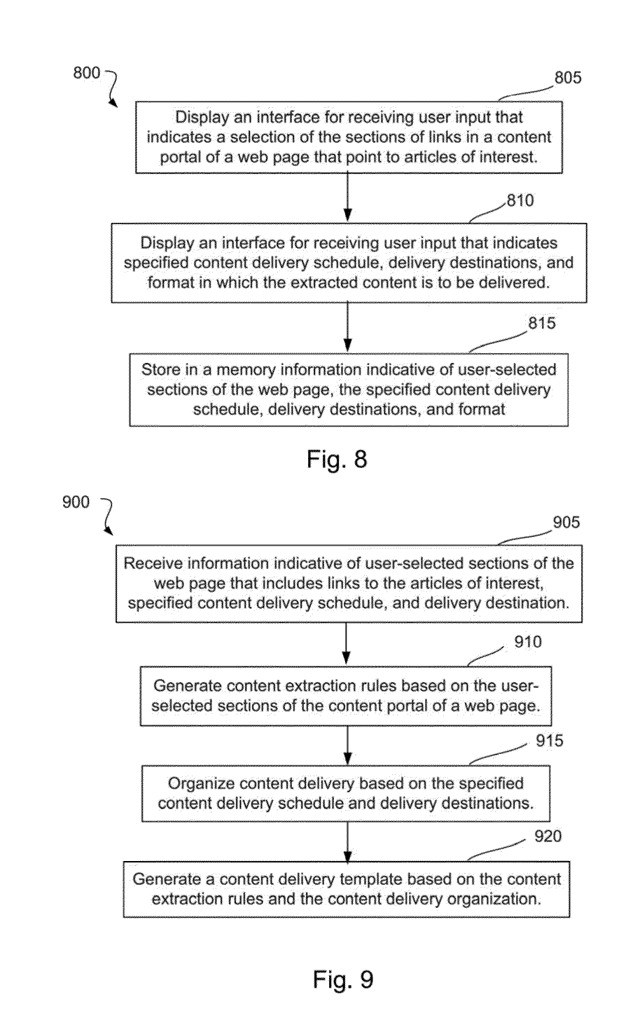

Referring now to FIG. 8, a flowchart is shown of a method (800) summarizing an example procedure for receiving user input for use in configuring content delivery to the user. This method (800) may be performed by, for example, the processing unit (112, FIG. 11) coupled with content delivery system (10, FIG. 11). The method of FIG. 8 may be implemented by a client-based component of content delivery system 10. The method (800) includes displaying an interface for receiving user input (805) that indicates the selection of the sections of links in a content portal of a web page that point to the articles of interest, and displaying an interface for receiving user input (810) that indicates specified content delivery schedule, delivery destinations, and format in which the extracted content is to be delivered. In (815), the user input received in (805) (information indicative of user-selected sections of the web page) and (810) (specified content delivery schedule, delivery destinations, and delivered content format) are stored (815) to a memory.

In an example, a method for receiving user input for use in configuring content delivery to the user can be performed based on more than one web page. In this example, the method includes displaying at least one interface for receiving user input that indicates the selection of the sections of links in content portals of web pages that point to the articles of interest, and displaying at least one interface for receiving user input that indicates specified content delivery schedules, delivery destinations, and formats in which the extracted content is to be delivered. The user input received, including information indicative of user-selected sections of the web pages and specified content delivery schedules, delivery destinations, and delivered content formats, are stored to a memory. The delivery schedules, delivery destinations and formats for delivery of the extracted content can be specified as the same for content extracted from all web pages, different for content extracted from each different web page, or the same for content extracted from some web pages and not others.

Referring now to FIG. 9, a flowchart is shown of a method (900) summarizing an example procedure for generating content extraction rules and a content delivery template for use in content delivery. This method (900) may be performed by, for example, the processing unit (112, FIG. 11) coupled with content delivery system (10, FIG. 11). The method of FIG. 9 may be implemented by a server-based component of content delivery system 10. The method (900) includes receiving (905) information indicative of user-selected sections of the web page that includes links to the articles of interest, specified content delivery schedule, and delivery destinations. The method (900) also includes generating (910) content extraction rules based on the user-selected sections of the content portal of the web page. In (915), the content delivery is organized based on the specified content delivery schedule, and delivery destinations. In (920), a content delivery template is generated based on the content extraction rules and the content delivery organization. The content delivery template can be stored on server. The content delivery template can be implemented to extract content based on the extraction rules and organize delivery of the extracted content to a user according to the pre-set schedule.

In an example, a method for generating content extraction rules and content delivery template(s) for use in content delivery can be performed based on more than one web page. In this example, the method includes receiving information indicative of user-selected sections of the web page that includes links to the articles of interest, specified content delivery schedule, and delivery destinations, and generating content extraction rules based on the user-selected sections of the content portals of the web pages. The method also includes organizing the content delivery based on the specified content delivery schedule, and delivery destinations, and generating at least one content delivery templates based on the content extraction rules and the content delivery organization. A single content delivery template can be generated for extracting content from all of the web pages, or different content delivery templates can be generated for extracting content from the web pages, in some combination.

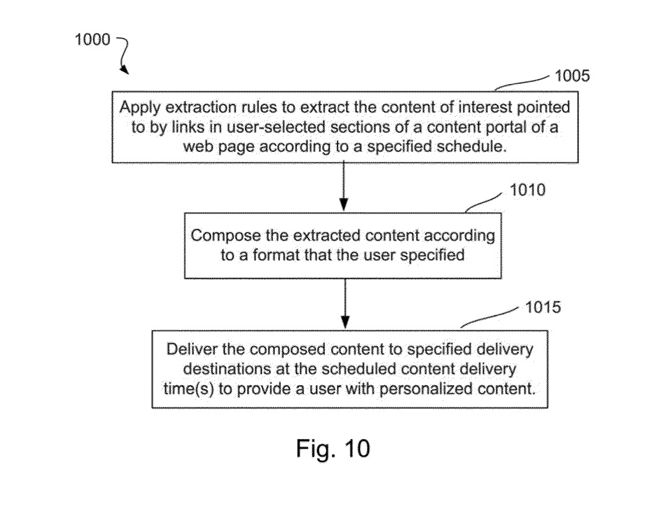

Referring now to FIG. 10, a flowchart is shown of a method (1000) summarizing an example procedure for extracting content according to the extraction rules and delivering the extracted content. This method (1000) may be performed by, for example, the processing unit (112, FIG. 11) coupled with content delivery system (10, FIG. 11). The method of FIG. 10 may be implemented by a server-based component of content delivery system 10. The method (1000) includes applying (1005) content extraction rules to extract the content of interest pointed to by links in the user-selected sections of a web page according to a specified schedule. The location of the user-selected section of the web page is inferred from the content extraction rules generated based on the first indication of the user-selected section, and does not need to be re-indicated by a user at a subsequent time. The method (1000) also includes composing (1010) the extracted content according to a format that the user specified. In (1015), the composed content is delivered to specified delivery destinations at the scheduled content delivery time(s) to provide a user with personalized content.

In an example, a method for generating content extraction rules and content delivery template(s) for use in content delivery can be performed based on more than one web page. In this example, the method includes applying content extraction rules to extract the content of interest pointed to by links in the user-selected sections of the web pages according to a specified schedule(s), and composing the extracted content according to the format(s) that the user specified. The method also includes delivering the composed content to specified delivery destinations at the scheduled content delivery time(s) to provide a user with personalized content. The content extracted forum the web pages can be composed into a single final document, or multiple documents, as specified by the user.

FIG. 11 shows an example of a computer system 110 that can implement any of the examples of the components of content delivery system 10 that are described herein. For example, computer system 110 could be used to function as the client-based component, as the server-based component, or both client-based and server-based components of content delivery system 10. In an example, the computer system 110 is a portable device or a computer-based viewing device described herein. Although each element is illustrated as a single component, it should be appreciated that each illustrated component can represent multiple similar components, including multiple components distributed across a cluster of computer systems. The computer system 110 includes a processing unit 112 (CPU), a system memory 114, and a system bus 116 that couples processing unit 112 to the various components of the computer system 110. The processing unit 112 typically includes one or more processors or coprocessors, each of which may be in the form of any one of various commercially available processors. The system memory 114 typically includes a read only memory (ROM) that stores a basic input/output system (BIOS) that contains start-up routines for the computer system 110 and a random access memory (RAM). System memory 114 may be of any memory hierarchy or complexity in the art. The system bus 116 may be a memory bus, a peripheral bus or a local bus, and may be compatible with any of a variety of bus protocols, including PCI, VESA, Microchannel, ISA, and EISA. The illustration shows a single system bus 116, however computer system 110 may include multiple busses. The computer system 110 may include a persistent storage memory 118 (e.g., a hard drive, a floppy drive, a CD ROM drive, magnetic tape drives, flash memory devices, and digital video disks) that is connected to the system bus 116 and contains one or more computer-readable media disks that provide non-volatile or persistent storage for data, data structures and other computer-executable instructions.

Interactions may be made with the computer system 110 (e.g., by entering commands or data) using one or more input devices 120 (e.g., a keyboard, a computer mouse, a microphone, joystick, or a touch pad). Information may be presented through a user interface that is displayed to a user on the display 121 (implemented by, e.g., a display monitor or display screen), which is controlled by a display controller 124. The display controller may be implemented by, e.g., a video graphics card. The display 121 can be a display screen of a portable viewing device or computer-based viewing device. The computer system 110 may includes peripheral output devices, such as speakers and a printer. In an example where computer system 110 is, e.g., a desktop computer, a laptop computer, may include a network interface card (NIC) 126 that facilitates connection with one or more remote computers.

As shown in FIG. 11, the system memory 114 can store one or more components of the content delivery system 10, a graphics driver 128, and processing information 160 that includes input data, processing data, and output data. In some examples, the content delivery system 10 interfaces with the graphics driver 128 to present a user interface on the display 121 for managing and controlling the operation of the content delivery system 10.

Content delivery system 10 may include one or more discrete data processing components, each of which may be in the form of any one of various commercially available data processing chips. In some implementations, the content delivery system 10 is embedded in the hardware of any one of a wide variety of digital and analog computer devices, including desktop, workstation, server computers, portable devices, and computer-based viewing devices, in some examples, the content delivery system 10 executes process instructions (e.g., machine-readable code, such as computer software) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

The principles set forth herein extend equally to any alternative configuration in which content delivery system 10 has access to web content 12. As such, alternative examples within the scope of the principles of the present specification include examples in which the content delivery system 10 is implemented by the same computer system, examples in which the functionality of the content delivery system 10 is implemented by a multiple interconnected computers (e.g., partially on a server in a data center and partially on a user's client machine), and examples in which the content delivery system 10 communicates with portions of computer system 110 directly through a bus without intermediary network devices.

The preceding description has been presented only to illustrate and describe embodiments and examples of the principles described. This description is not intended to be exhaustive or to limit these principles to any precise form described. Many modifications and variations are possible in light of the above teaching.

Many modifications and variations of this invention can be made without departing from its spirit and scope, as will be apparent to those skilled in the art. The specific examples described herein are offered by way of example only, and the invention is to be limited only by the terms of the appended claims, along with the full scope of equivalents to which such claims are entitled.

As an illustration of the wide scope of the systems and methods described herein, the systems and methods described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise.

What is claimed is:

1. A system to deliver personalized content to a user, the system comprising:
memory for storing computer executable instructions; and
a processing unit for accessing the memory and executing the computer executable instructions, the computer executable instructions comprising:
an engine to apply content extraction rules based on at least one pre-determined delivery schedule to extract content of interest pointed to by links in user-selected sections of at least one content portal of at least one web page regardless of changes in the links in the at least one content portal; and
a module to compose the extracted content in a layout format to provide personalized content,
wherein the system comprises computer executable instructions to deliver the personalized content to at least one pre-determined destination according to the at least one pre-determined delivery schedule.

2. The system of claim 1, wherein the personalized content is delivered as a web page based on a markup language file, as a PDF, or in an electronic book format.

3. The system of claim 1, wherein the memory and the processing unit are part of a server-based component of the system.

4. The system of claim 1, further comprising computer executable instructions to generate the content extraction rules by a method comprising:
receiving information indicative of user-selected sections of the at least one content portal of the at least one web page and the at least one pre-determined delivery schedule; and
generating the content extraction rules based on the user-selected sections of the at least one content portal.

5. The system of claim 4, wherein the computer executable instructions to receive information comprise instructions to:
display an interface to receive user input that indicates the selection of the sections of links in the at least one content portal of the at least one web page that point to articles of interest; and
display an interface to receive user input that indicates the at least one pre-determined delivery schedule.

6. The system of claim 5, wherein the interface to receive user input that indicates the at least one pre-determined delivery schedule also receives user input that indicates the at least one pre-determined destination and the layout format of the personalized content.

7. The system of claim 5, further comprising a processing unit for executing the computer executable instructions to display the interface to receive user input that indicates the selection of the sections of links in the at least one content portal of the at least one web page that point to articles of interest, and to display the interface to receive user input that indicates the at least one pre-determined delivery schedule, wherein the processing unit is part of a client-based component of the system.

8. The system of claim 7, wherein the client-based component is a smartphone, a tablet, a slate, a touch-based device, a laptop, or a notebook computer.

9. The system of claim 8, wherein the client-based component is the at least one pre-determined destination.

10. A method to deliver personalized content to a user, the method comprising:
applying, using a processing unit, content extraction rules based on at least one pre-determined delivery schedule to extract content of interest pointed to by links in user-selected sections of at least one content portal of at least one web page regardless of changes in the links in the at least one content portal;
composing, using a processing unit, the extracted content to a layout format to provide personalized content; and
delivering, using a processing unit, the personalized content to at least one pre-determined destination according to the at least one pre-determined delivery schedule.

11. The method of claim 10, wherein the personalized content is delivered as a web page based on a markup language file, as a PDF, or in an electronic book format.

12. The method of claim 10, further comprising:
receiving, using a processing unit, information indicative of user-selected sections of the at least one content portal of the at least one web page and the at least one pre-determined delivery schedule; and
generating, using a processing unit, the content extraction rules based on the user-selected sections of the at least one content portal.

13. The method of claim 12, wherein receiving the information comprises:
displaying, using a processing unit, an interface to receive user input that indicates the selection of the sections of links in the at least one content portal of the at least one web page that point to articles of interest; and
displaying, using a processing unit, an interface to receive user input that indicates the at least one pre-determined delivery schedule.

14. The method of claim 10, wherein the at least one pre-determined destination is at least one of smartphone, a tablet, a slate, a touch-based device, a laptop, or a notebook computer.

15. A non-transitory computer-readable medium having code representing computer-executable instructions encoded thereon, the computer executable instructions comprising instructions executable to cause one or more processing units to:
apply content extraction rules based on at least one pre-determined delivery schedule to extract content of interest pointed to by links in user-selected sections of at least one content portal of at least one web page regardless of changes in the links in the at least one content portal;
compose the extracted content in a layout format to provide personalized content; and
deliver the personalized content to at least one pre-determined destination according to the at least one pre-determined delivery schedule.
